(19) United States
(12) Patent Application Publication
(10) Pub. No.: US 2002/0162464 A1
(43) Pub. Date: Nov. 7, 2002

(54) Compressed embossed fabric article and method for manufacturing same

(76) Inventor: Alan Davis, San Diego, CA (US)

Correspondence Address: BROWN, MARTIN, HALLER & MCCLAIN LLP, 1660 UNION STREET, SAN DIEGO, CA, 92101-2926, US

(21) Appl. No.: 09/850,873

(22) Filed: May 7, 2001

(51) Int. Cl. B31F 1/07; B44B 5/00

(52) U.S. Cl. 101/3.1

(57) ABSTRACT

A compressed fabric article having embossed indicia thereon, and a method for its manufacture, are disclosed. The compressed fabric article may have its embossed indicia impressed into its surface, or it may have its embossed indicia projecting outwardly from its surface, or both. The article is formed by compressing a fabric article such as a shirt or towel in a mold while simultaneously using an inner surface of the mold or ram/piston to emboss the desired indicia on the surface of the compressed, molded fabric body. Multiple embossments can be made simultaneously. Upon opening a sealed package containing the compressed, embossed fabric article, the article can be opened out to its original configuration.

### BACKGROUND OF THE INVENTION

1. Field of the Invention

The invention herein relates to compressed fabric articles, particularly fabric articles such as garments and utility articles such as towels which are compressed into various shapes for use as promotional items and the like.

2. Description of the Prior Art

For the past several years there has been a growing market for compressed fabric articles for use as promotional items, souvenirs, gifts, commemorative items and the like. Typically the fabric item is a garment or a simple sheet fabric object. By far the most common are tee shirts, but other garments (“wearables”) such as scarves or utility items such as towels or a banners are possible or can be used. The tee shirts or other items are also commonly decorated or imprinted with a logo or wording. The fabric item may be compressed into a simple three-dimensional geometrical shape, such as a cube, ellipsoid or cylinder, but commonly it is compressed into a shape which has the general shape of a familiar object, such as a star, a car or boat, a bottle or a hand tool. The compressed article in the desired shape is wrapped into a package while in its compressed state, and once distributed for instance as a promotional item, can be unwrapped by the recipient, decompressed and opened out to its original configuration as the real shirt, towel, etc. that it is. The recipient therefore sees and enjoys the unique compressed shape of the original package, recognizes the advertising or other message intended by the vendor for the compressed package, and then after opening the package also obtains the benefit of having a usable garment, towel or other useful fabric product.

As will be recognized, since fabric cannot be formed into a body having particularly sharp corners, and since many common items have detailed and complex shapes, the compressed package merely simulates the overall shape of the familiar object. It is common for vendors to place a flat sheet insert having a picture of the familiar object adjacent to one or more outer surfaces of the compressed fabric article, so that when the compressed fabric article is covered by a transparent package wrapping the picture will be visible through the wrapping and reinforce the recipient's recognition of the shape or object that the compressed fabric article is intended to represent.

It is also known for such compressed fabric articles to have other objects, usually of a similar shape, included in the same package, so that the recipient of the packaged article received not only the fabric shirt, towel, etc., but also another promotional item at the same time. Such included items may include money, CDs, video or audio cassettes. Such items are of course packaged with the compressed fabric article after compression of the latter has been completed.

Typical examples of compressed fabric articles of the types describe above, both with and without sheet inserts or other promotional items included in their packaging, are found in my previously issued design patents, including but not limited to those articles shown in U.S. design patent Nos. D-411,799 (Jul. 6, 1999), D-423,931 (May 2, 2000); D-431,184 (Sep. 26, 2000); D-431,185 (Sep. 26, 2000); D-431,186 (Sep. 26, 2000); D-431,187 (Sep. 26, 2000); D-431,456 (Oct. 3, 2000); D-431,773 (Oct. 10, 2000); and D-431,774 (Oct. 10, 2000).

Heretofore, however, it has never been considered that shapes, graphics, pictures or other indicia could be incorporated into a compressed fabric article in any manner other than by means of the general outer shape of the compressed package or by means of a preprinted insert sheet. No vendor of compressed fabric products has heretofore disclosed or suggested any manner in which the fabric item itself—i.e., the shirt, towel, etc.—could have imparted directly to its surface detailed, finely wrought graphics, writing or other indicia.

### SUMMARY OF THE INVENTION

I have now developed a method for embossing at least one surface of a compressed fabric body so that alphanumeric characters, graphics or other indicia are formed on such surface of the fabric body and there retained in clear and sustained form when the compressed body is packaged, and continue to be so retained until the recipient of the package opens it and removes and opens up the fabric body to expose its true shirt, towel, etc. nature. The embossing accomplished by my method invention does not harm the surface of the fabric body in any manner, and once the recipient has removed the package wrapping and opened out the fabric body as, for instance, a shirt, the shirt does not unduly retain any of the embossed impression. My invention also includes the unique and novel resulting compressed, embossed fabric article.

The original fabric body may be of any compressible fabric material, such as a woven or felted fabric. The most preferred fabric is cotton, which is inexpensive, readily resumes its shape and eliminates creases and wrinkles after opening, and accepts printing and decoration well. However, it is also contemplated that other natural, synthetic, metallic, etc. fabrics may also be used, individually or in blends. For instance, blends of cotton with synthetic fibers, such as polyester fiber, are contemplated. Fabrics may be woven, felted or otherwise formed by conventional methods. The critical requirement is that the fabric chosen must be sufficiently flexible to be able to be highly compressed into a small package with (usually) an irregular shape without adverse effects to overall fabric or the individual fibers from which it is made. Other properties, such as cost or ability to eliminate wrinkles and creases after opening, may be important or not in the view of individual users of the products. While it will thus be recognized that there are many suitable fabrics, for brevity herein the invention will be exemplified in its most common embodiment, i.e., as a cotton fabric product, namely a tee shirt.

In the present invention, one first constructs a mold comprising a molding chamber whose inner wall surfaces define both the size of the finished compressed fabric article and its overall configuration. For example, in the Figures of this application, the compressed fabric article is formed into a flat triangular body in a mold whose inner surface is of the same shape. Such mold formation and compression molding of items, whether of fabric or other material, are well known and need not be described further.

The present invention, however, includes the unique and heretofore undisclosed aspect of simultaneously embossing directly to and into the surface of the body being compressed detailed, finely wrought graphics, writing or other indicia. This is accomplished by compressing the fabric body within the mold under a pressure sufficient to impart a sustainable density to the article which is high enough that embossment simultaneously imparted will be incorporated into and retained by the compressed fabric article until and after that article is removed form its package and until its original uncompressed configuration is restored by opening it out. I have found that for most common cotton items, such as shirts, towels and the like, the article must be compressed under a force of at least 2000 lbs/sq in [psi] (1.38 MPa), more preferably in the range of 2000-5000 psi (1.38-3.45 MPa), to impart sufficient density and stiffness to the fabric body to retain the embossing. The package is then normally shrink wrapped with a transparent polymeric film so that it retains its shape and the embossed image will be visible through the wrapping.

Note that the compression pressure is based on essentially dry compression of the fabric body. It is known that a fabric body may in some cases be compressible to a given density under less pressure if the fabric is wetted prior to the compression. However, any significant amount of wetting is detrimental in most cases, since the moisture is retained in the wetted, compressed fabric body once it is formed and packaged, and such trapped moisture can quickly degrade the fabric body itself, the packaging or any writing, graphics or other indicia printed on the fabric body or any package insert.

In the present invention, either or both the face of the compression piston or the floor of the mold cavity is formed into a “negative” of the pattern desired to be embossed onto the compressed fabric body. Where the negative is formed with a raised portion of the pattern, the fabric product will be embossed with a corresponding recessed or impressed portion of the pattern, and vice versa. Thus one may impart a pattern onto the fabric body's surface which is entirely impressed into the surface, projects outwardly from the surface, or includes regions of both types within the pattern.

Therefore, in a principal embodiment, the invention involves a compressed fabric article having embossed indicia incorporated on at least one surface thereof. Such compressed fabric article may have its embossed indicia impressed into its surface, or it may have its embossed indicia projecting outwardly from its surface, or both.

In yet another principal embodiment, the invention involves a method for the formation of a compressed, embossed fabric article which comprises providing a mold having a chamber therein for forming the principal external shape of a fabric object compressed therewithin and compression means cooperative therewith to compress the fabric object within the chamber and impart to the object a remaining segment of the principal external shape; providing on at least one of a portion of a surface of the chamber or a face of the compression means negative embossing indicia; placing the fabric object into the chamber and compressing it therein with the compression means to a density and for a time period sufficient for the negative embossing indicia to form corresponding positive indicia on a surface of the fabric object; and thereafter removing the compressed embossed fabric article comprising the compressed fabric body with the positive indicia embossed thereon from the mold. Multiple embossments can be obtained by various configurations of the mold, the compression ram or piston and the fabric object, and, as mentioned above, the embossments can result in impressed or projecting indicia.

### BRIEF DESCRIPTION OF THE DRAWINGS

FIG. 1 is a perspective view of a mold negative in the form of the face of a compression piston.

FIG. 2 is a size elevation view illustrating the compression of a fabric body into a mold chamber using the piston of FIG. 1.

FIG. 3 is a perspective view of the molded, compressed fabric article to which the indicia of the piston face of FIG. 1 have been transferred in corresponding positive mode to the surface of the article.

### DETAILED DESCRIPTION AND PREFERRED EMBODIMENTS

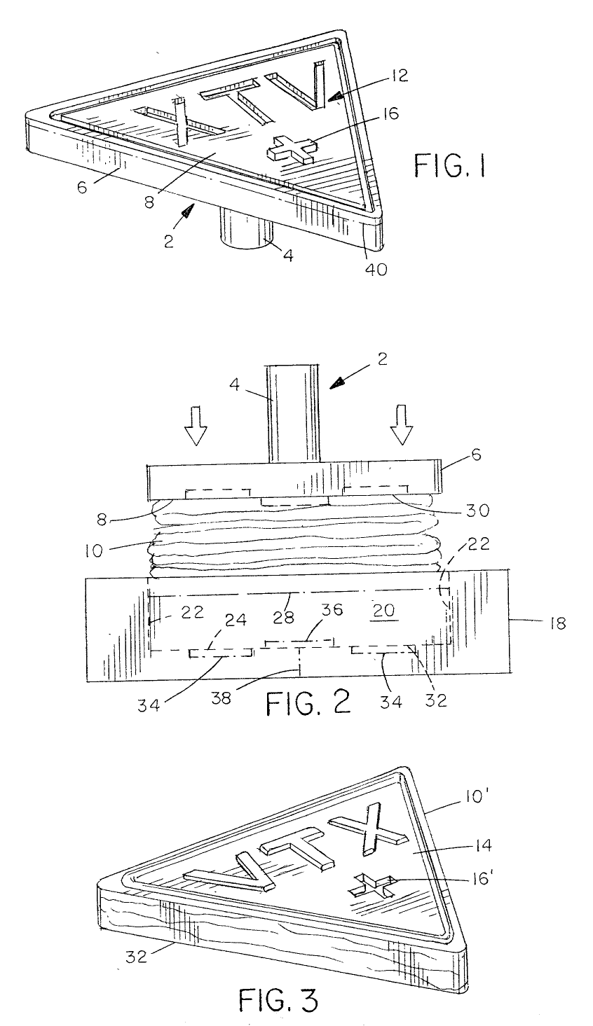

The invention herein is best understood by reference to the Figures of the drawings. For the purposes of this discussion, the mold will be considered to be a simple piston-and-chamber mold with the embossing negative surface to be the face of the piston head. (Other embodiments will be mentioned below.) FIG. 1 shows the ram or piston 2 having a driving shaft 4 and a flat head 6. On the face 8 of the head 6 which contacts the fabric body 10 is formed a negative pattern 12 corresponding to what is intended to be the positive pattern imparted to the compressed fabric body 10′. In this illustration the pattern is of the letters X, T and V which are recessed into the negative face 8 so that when the pattern is imparted to the fabric body it will result in the corresponding letters projecting outwardly from the fabric body's surface 14, as shown in FIG. 3. Also shown in FIG. 1 as part of the embossing pattern is a cross 16 which projects outwardly from the negative face 8 of the piston 2, so that upon embossing the cross will form a corresponding impressed cross 16′ in the surface 14 of the compressed fabric body 10′, also as illustrated in FIG. 3. It will be evident that the embossing face 8 can also be a negative in which there are only recessed indicia (such as the letters X, T and V) or all projecting indicia (such as the cross 16), which of course will produce the corresponding reversed embossed positive images on the compressed fabric body.

FIG. 2 shows the embossing operation. The mold 18 is chosen or manufactured to have a mold cavity 20 whose inner walls 22 and bottom 24 are shaped exactly like the desired final outward shape of all sides but one of the intended final compressed article. (The shape and configuration of the remaining side will be formed by the face 8 of the piston head 6 during compression.) The dry or substantially dry fabric item 10, such as a tee shirt, is folded carefully both to fit into the mold and be compressed without undue stress focused on any one portion of the fabric body, and also with consideration for the ability of the recipient to open out and use the original shirt after he or she receives the compressed package as a promotion, gift, etc. The folded shirt is then placed into the mold cavity 20 and the mold piston is moved downwardly forcing the bulk of the shirt body 10 further into the mold cavity 20 as the pressure on the shirt increases. Eventually the entire shirt is within the mold cavity 20 with its top surface 30 recessed to the level of the line 28, so that at last a portion of the thickness of the piston head 6 fills part of the mold cavity 20 above line 28. The final location 28 of the interface between the piston face 8 and the shirt surface 30 will be determined by the size of the mold and the degree to which the shirt can or will be compressed. Those skilled in the art of the molding will be readily able to determine the appropriate degree of compression for any fabrics of interest. It is required, however, that the degree of compression be such that, as discussed above, the embossed indicia are cleanly impressed into or projected from the shirt surface 30 in a manner which will permit their retention without undue relaxation until the recipient finally opens the compressed package and opens out the shirt to its original configuration.

I have found that for most cotton fabrics the minimum pressure should be at least about 2000 psi (1.38 MPa) and preferably will be within the range of about 2000-5000 psi (1.38-3.45 MPa). Of course, the pressure must be maintained for a period of time sufficient to insure both that the shirt properly fills the mold cavity so that the desired overall outer shape is achieved and also that complete formation of the embossed indicia is obtained. Dwell times for the press will be on the order of 0.01-5.0 seconds, preferably 0.1-3.0 seconds. Dwell times and peak pressure are inversely related, in that a longer dwell time at a lower peak pressure can produce the same degree and clarity of embossing of the shirt as a higher peak pressure maintained for a shorter dwell time. Those skilled in the art can readily determine the optimum combination of dwell time and peak pressure to obtain the desired embossing while yet avoiding excess stress or wear on either the press or the fabric.

Once the fabric body has been fully compressed, shaped and embossed, the piston 2 is withdrawn from the mold cavity 20 and the pressure relieved on the compressed fabric product. While there may be some small degree of resilient expansion of the compressed body 10′, I have not found that to be significant when the time-and-pressure relationships mentioned above are utilized. The compressed, embossed fabric article can then be removed from the mold and wrapped to form the desired product package. The wrapping will be transparent (although it need not be devoid of color) so that the embossing on the enclosed compressed fabric article can be viewed. Usually the wrapping will be applied by compression wrapping with a stretched elastic wrapping film (such as a polymeric material), but it could also be applied by shrink wrapping with a shrinkable film which is heated after wrapping to effect the shrinkage. Such wrapping is conventional for compressed fabric products and the use of the conventional techniques will not be affected by the presence of the embossed areas, except that projective embossing may be flattened somewhat if there is high tension imparted to the film by its shrinkage or resilient elasticity.

It will also be recognized that the underside 32 of the compressed fabric article 10′ may also be embossed by the bottom 24 of the mold cavity 20 having appropriate recessed negative indicia 34 or projecting negative indicia 36 to form corresponding projecting or impressed positive indicia (not shown) on the bottom of the article 10′. Also, if the compressed fabric body 10′ is molded with a portion of the bottom or top having a curved outer surface, that curved surface may also be embossed in the same manner.

In the embodiments shown, it is the top and/or bottom surfaces of the compressed fabric article 10′ which are embossed. The sides of the compressed article may also be embossed, if the mold is modified to have at least one parting line 38 so that the mold can be separated into at least two sections which are moveable relative to each other. This is necessary since to retain the embossing following molding the compressed article must be separated from the mold chamber or piston face without twisting or turning the embossed sections. In a one-piece mold this movement can be accomplished only for the top surface 8 or bottom surface 32 of the compressed fabric article 10′. Multi-piece molds can be of many configurations, including but not limited to ones in which various sides of the mold can be individually removed. Those familiar with mold design and operation will be readily able to design and construct molds appropriate for embossing of any desired surface of a compressed fabric article 10′.

The mold parts will be made of materials which are capable of withstanding the required molding pressures mentioned above. Typically the principal components of the mold (including the chamber and piston) will be made of a steel alloy or a hard ceramic material. It is contemplated that the negative embossing surfaces may either be part of the mold chamber bottom or wall or piston head face directly, or they may be formed as relatively thin embossing plate(s) of metal, hard ceramic or hard plastic which can be placed on or secured to the mold cavity bottom or piston head face as indicated, for instance, as an alternative embodiment at 40 in FIG. 1. By use of such separate embossing plates a wide variety of embossed articles may be made with a single mold without having to modify the main mold structure itself. Methods and structures for removably securing such plates to mold chamber walls or bottoms or piston faces are well known to those skilled in the art.

The compressed, embossed fabric articles 10′ of the present invention may be formed from any desired fabric item, to which of course they revert once the compressed, embossed package is opened by the recipient. Such items may be garments such as shirts, blouses, scarfs, handkerchiefs, socks or the like; utility items such as towels, face cloths, wiping cloths, dust covers and the like; or other fabric items such as flags, banners and wall hangings. Other suitable products will be readily apparent to those skilled in the art. Since in most cases the compressed articles will be used as promotional items, the final compressed packaged are usually relatively small, commonly having a largest dimension of 12-15 inches (30-38 cm) or less. This of course also simplifies the molding equipment needed. However, it is contemplated that the present invention also includes embossment of larger compressed fabric articles, since such will require no more than routine scale-up of embossing of the smaller articles, which is well within the skill of those in the art. Similarly, while it is preferred that the fabric items be entirely of cloth or synthetic fabric with no attachments such as buttons, embossing of items with such attachments is fully contemplated within this invention. This can be easily accomplished by appropriate planning of the initial folding of the fabric item so that the buttons or other attachments do not get broken by the subsequent molding pressure, do not snag on any portion of the mold walls or piston and avoid becoming located within the chamber in a position in which they will interfere with clean impression of the embossment.

The compressed, embossed fabric articles of this invention can of course very usefully be combined in packaging with additional items such as money, CDs, audio and video tapes, or other promotional, gift or similar items.

It will be evident that there are numerous embodiments of the present invention which are not expressly described above, but which are clearly within the scope and spirit of the invention. The above description is therefore to be considered exemplary only, and the actual scope of the invention is to be defined solely by the appended claims.

I claim:

1. A compressed fabric article having embossed indicia incorporated on at least one surface thereof.

2. A compressed fabric article as in claim 1 where said embossed indicia are impressed into said surface.

3. A compressed fabric article as in claim 1 where said embossed indicia project outwardly from said surface.

4. A compressed fabric article as in claim 1 further comprising a woven or felted cloth article.

5. A compressed fabric article as in claim 4 wherein said woven or felted cloth article comprises a garment, utility item, flag, banner or wall hanging.

6. A compressed fabric article as in claim 5 wherein said garment comprises a shirt, blouse, scarf, handkerchiefs or socks.

7. A compressed fabric article as in claim 5 wherein said utility item comprises a towel, face cloth, wiping cloth or dust cover.

8. A method for the formation of a compressed, embossed fabric article which comprises:
providing a mold having a chamber therein for forming the principal external shape of a fabric object compressed therewithin and compression means cooperative therewith to compress said fabric object within said chamber and impart to said object a remaining segment of said principal external shape;
providing on at least one of a portion of a surface of said chamber or a face of said compression means negative embossing indicia;
placing said fabric object into said chamber and compressing it therein with said compression means to a density and for a time period sufficient for said negative embossing indicia to form corresponding positive indicia on a surface of said fabric object; and
thereafter removing said compressed embossed fabric article comprising said compressed fabric body with said positive indicia embossed thereon from said mold.

9. A method as in claim 8 wherein said negative embossing indicia are recessed into said face or said bottom such that said positive indicia are formed projecting outwardly from a surface of said compressed, embossed fabric article.

10. A method as in claim 8 wherein said negative embossing indicia project outwardly from said face or said bottom such that said positive indicia are impressed into a surface of said compressed, embossed fabric article.

11. A method as in claim 8 wherein pressure imparted to said fabric body in said mold is at least 2000 psi maintained for a dwell time sufficient to compress said fabric body and emboss said positive indicia thereon.

12. A method as in claim 11 wherein said dwell time comprises at least 0.01 seconds.

13. A method as in claim 12 wherein said pressure is at least 1000 psi and said dwell time is in the range of 0.01-5.0 seconds.

14. A method as in claim 13 wherein said pressure is in the range of 1000-5000 psi and said dwell time is in the range of 0.1-3.0 seconds.

15. A method as in claim 8 wherein said fabric body comprises a garment, utility item, flag, banner or wall hanging.

16. A method as in claim 8 wherein said compression means comprises a ram or piston which cooperates with said chamber to cause said fabric body to form its desired external shape while being compressed.

17. A method as in claim 8 wherein said compression of said fabric body forming a compressed fabric article with at least one distinct top or bottom face, and said positive indicia are embossed on said face.

18. A method as in claim 8 further comprising providing a plurality of said negative embossing indicia at least one of said surface of said chamber or face of said compression means.

19. A method as in claim 18 further comprising said compression forming a compressed, embossed fabric article having a plurality of positive indicia equal in number to said plurality of negative embossing indicia embossed thereon.

20. A method as in claim 8 further comprising providing as said mold a multipiece member which allows segmentation of a wall of said chamber, and following said compressing said fabric body within said chamber, separating said multipiece member to effect said segmentation of said wall of said chamber such that said compressed, embossed fabric article can be removed from said chamber with all positive indicia embossed thereon remaining intact.

21. A method as in claim 8 further comprising packaging said compressed, embossed fabric article within a transparent wrapping.

22. A method as in claim 21 further comprising removing said wrapping and causing said compressed, embossed fabric article to resume its original configuration, whereupon said positive indicia disappear.
